(19) United States
(12) Patent Application Publication
(10) Pub. No.: US 2020/0134690 A1
(43) Pub. Date: Apr. 30, 2020

(54) SYSTEMS AND METHODS FOR PROVING A FINANCIAL PROGRAM FOR BUYING A VEHICLE

(71) Applicant: BEIJING DIDI INFINITY TECHNOLOGY AND DEVELOPMENT CO., LTD., Beijing (CN)

(72) Inventors: Yu WANG, Beijing (CN); Chunliang WANG, Beijing (CN); Zhou YE, Beijing (CN); Rui GUO, Beijing (CN); Duokun ZHANG, Beijing (CN)

(73) Assignee: BEIJING DIDI INFINITY TECHNOLOGY AND DEVELOPMENT CO., LTD., Beijing (CN)

(21) Appl. No.: 16/727,013

(22) Filed: Dec. 26, 2019

Related U.S. Application Data
(63) Continuation of application No. PCT/CN2017/090780, filed on Jun. 29, 2017.

(51) Int. Cl. G06Q 30/06; G06Q 50/30; G06Q 40/02; G06Q 30/02

(52) U.S. Cl. CPC G06Q 30/0627; G06Q 30/0201; G06Q 40/025; G06Q 50/30

(57) ABSTRACT

A system may include at least one computer-readable storage medium including a set of instructions for providing a driver registered in an online platform with a financial program for buying a vehicle, and at least one processor in communication with the computer-readable storage medium, wherein when executing the set of instructions, the at least one processor is directed to: receive data of a plurality of drivers registered in the online platform from an input device, the data including usage history of a plurality of vehicles associated with the plurality of drivers; identify from the plurality of drivers a first group of candidate drivers based on the usage history, each candidate driver is associated with a purchase intention higher than a threshold value; and save a first structured data in the storage medium to identify the first group of candidate drivers.

### CROSS-REFERENCE TO RELATED APPLICATIONS

This application is a continuation of International Application No. PCT/CN2017/090780, filed on Jun. 29, 2017, the contents of which are incorporated herein by reference.

### TECHNICAL FIELD

The present disclosure generally relates to technology field of on-demand service, and in particular, systems and methods for providing a driver with a financial program for buying a vehicle.

### BACKGROUND

On-demand service, such as online taxi hailing service, has become more and more popular. An online platform of the on-demand service has a large number of drivers registered therein and a large number of vehicles associated with the drivers. The demand for buying vehicles of the drivers registered in the online platform has become more and more common. Therefore, it is desirable to provide systems and methods for identifying a group of candidate drivers who have purchase intentions, for determining purchasing capacity of the group of candidate drivers, for providing financial programs for the group of candidate drivers for buying vehicles, and for providing target vehicles for the group of candidate drivers.

### SUMMARY

According to an aspect of the present disclosure, a system may include at least one computer-readable storage medium including a set of instructions for providing a driver registered in an online computer platform with a financial program for buying a vehicle, and at least one processor in communication with the computer-readable storage medium, wherein when executing the set of instructions, the at least one processor is directed to: receive first electrical currents from at least one input device of the system, the first electrical currents encoding data of a plurality of drivers registered in the online computer platform, the data including usage history of a plurality of vehicles associated with the plurality of drivers; identify, from the plurality of drivers, a first group of candidate drivers based on the usage history of the plurality of vehicles, each candidate driver is associated with a purchase intention higher than a threshold value; and send second electrical currents to at least one output device to direct the at least one output device to write a structured data in the storage medium to identify the first group of candidate drivers.

In some embodiments, the usage history includes at least one of: driving routes of a vehicle of the plurality of vehicles; driving duration of the plurality of vehicles over the driving routes; active duration of the plurality of drivers in the plurality of vehicles; fueling history of the plurality of vehicles; maintenance history (with vehicle maintenance centers/auto repair stations registered with the online computer platform) of the plurality of vehicles; or online browsing history relating to vehicle purchasing.

In some embodiments, to identify the first group of candidate drivers, the at least one processor is further directed to: identify, from the plurality of drivers, a second group of buyer drivers having actual vehicle purchasing history; for a driver of the plurality of drivers, determine an overall similarity between the driver and the second group of buyer drivers based on a hyper-parameter and the usage history of a vehicle associated with the driver; determine a purchase intention of the driver based on the overall similarity; and send third electrical currents to the at least one output device to direct the at least one output device to write a structured data in the storage medium to: identify the driver as a candidate driver when the purchase intention is greater than the threshold value; and include the purchase intention of the driver in a purchase intention data set.

In some embodiments, to identify the second group of buyer drivers having actual vehicle purchasing history, the at least one processor is further directed to: access the storage medium of the online computer platform to obtain driver information of the plurality of drivers and vehicle information associated with the plurality of drivers; access the storage medium of the online computer platform to obtain online browsing history relating to vehicle purchasing of the plurality of drivers; determine the second group of buyer drivers having actual vehicle purchasing history based on the driver information, the vehicle information and the online browsing history; and write a structured data in the storage medium to identify the second group of buyer drivers.

In some embodiments, the at least one processor is further directed to: access the storage medium of the online computer platform to obtain from the purchase intention data set target purchase intention data associated with a target driver in the plurality of drivers; execute a purchasing capacity prediction model to generate target purchasing capacity data of the target driver based on the target purchase intention data; access the storage medium to read a database of financial programs; determine a financial program from the database of financial programs based on the target purchasing capacity data of the target driver; and write a structured data in the storage medium, the structured data associated the target driver with the target financial program.

In some embodiments, the at least one processor is further directed to: access the storage medium of the online computer platform to obtain vehicle types that the second group of buyer drivers have bought and the corresponding fair market prices; access the storage medium to obtain usage history of the vehicles associated with the second group of buyer drivers; determine a purchasing capacity prediction model based on the vehicle types, the corresponding fair market prices and the usage history of the vehicles associated with the second group of buyer drivers; and write a structured data in the storage medium to identify the purchasing capacity prediction model.

In some embodiments, the at least one processor is further directed to: access the storage medium of the online computer platform to obtain, from the purchase intention data set, target purchase intention data associated with a target driver in the plurality of drivers; access the storage medium to obtain a database including information of a plurality of on-sale-vehicles; select, from the plurality of on-sale-vehicles, a target vehicle based on the usage history of the vehicle associated with the target driver; and write a structured data in the storage medium, the structured data associated the target driver with the target vehicle.

According to another aspect of the present disclosure, a method for providing a driver registered in an online computer platform with a financial program for buying a vehicle may include: receiving first electrical currents from at least one input device of a system, the first electrical currents encoding data of a plurality of drivers registered in the online computer platform, the data including usage history of a plurality of vehicles associated with the plurality of drivers; identifying from the plurality of drivers a first group of candidate drivers based on the usage history of the plurality of vehicles, each candidate driver is associated with a purchase intention higher than a threshold value; and sending second electrical currents to at least one output device to direct the at least one output driver to writing a structured data in a storage medium to identify the first group of candidate drivers.

In some embodiments, usage history includes at least one of: driving routes of a vehicle of the plurality of vehicles; driving duration of the plurality of vehicles over the driving routes; active duration of the plurality of drivers in the plurality of vehicles; fueling history of the plurality of vehicles; maintenance history (with vehicle maintenance centers/auto repair stations registered with the online computer platform) of the plurality of vehicles; or online browsing history relating to vehicle purchasing.

In some embodiments, the identifying the first group of candidate drivers may include identifying from the plurality of drivers a second group of buyer drivers having actual vehicle purchasing history; for a driver of the plurality of drivers, determining an overall similarity between the driver and the second group of buyer drivers based on a hyper-parameter and the usage history of a vehicle associated with the driver; determining a purchase intention of the driver based on the overall similarity; and sending third electrical currents to the at least one output device to direct the at least one output device to write a structured data in the storage medium to: identify the driver as a candidate driver when the purchase intention is greater than the threshold value; and include the purchase intention of the driver in a purchase intention data set.

In some embodiments, the identifying the second group of buyer drivers having actual vehicle purchasing history may include accessing the storage medium of the online computer platform to obtain driver information of the plurality of drivers and vehicle information associated with the plurality of drivers; accessing the storage medium of the online computer platform to obtain online browsing history relating to vehicle purchasing of the plurality of drivers; determining the second group of buyer drivers having actual vehicle purchasing history based on the driver information, the vehicle information and the online browsing history; and writing a structured data in the storage medium to identify the second group of buyer drivers.

In some embodiments, the method may further include: accessing the storage medium of the online computer platform to obtain from the purchase intention data set target purchase intention data associated with a target driver in the plurality of drivers; executing a purchasing capacity prediction model to generate target purchasing capacity data of the target driver based on the target purchase intention data; accessing the storage medium to read a database of financial programs; determining a financial program from the database of financial programs based on the target purchasing capacity data of the target driver; and writing a structured data in the storage medium, the structured data associated the target driver with the target financial program.

In some embodiments, the method may further include: accessing the storage medium of the online computer platform to obtain vehicle types that the second group of buyer drivers have bought and the corresponding fair market prices; accessing the storage medium to obtain usage history of the vehicles associated with the second group of buyer drivers; determining a purchasing capacity prediction model based on the vehicle types, the corresponding fair market prices and the usage history of the vehicles associated with the second group of buyer drivers; and writing a structured data in the storage medium to identify the purchasing capacity prediction model.

In some embodiments, the method may further include: accessing the storage medium of the online computer platform to obtain, from the purchase intention data set, target purchase intention data associated with a target driver in the plurality of drivers; accessing the storage medium to obtain a database including information of a plurality of on-sale-vehicles; selecting, from the plurality of on-sale-vehicles, a target vehicle based on the usage history of the vehicle associated with the target driver; and writing a structured data in the storage medium, the structured data associated the target driver with the target vehicle.

According to still another aspect of the present disclosure, a non-transitory computer readable medium, comprising at least one set of instructions for providing a driver registered in an online computer platform with a financial program for buying a vehicle, when executed by at least one processor of a computer server, the at least one set of instructions directs the at least one processor to perform acts of: receiving first electrical currents from at least one input device of a system, the first electrical currents encoding data of a plurality of drivers registered in the online computer platform, the data including usage history of a plurality of vehicles associated with the plurality of drivers; identifying from the plurality of drivers a first group of candidate drivers based on the usage history of the plurality of vehicles, each candidate driver is associated with a purchase intention higher than a threshold value; and sending second electrical currents to at least one output device to direct the at least one output device to write a structured data in a storage medium to identify the first group of candidate drivers.

### BRIEF DESCRIPTION OF THE DRAWINGS

The present disclosure is further described in terms of exemplary embodiments. The foregoing and other aspects of embodiments of present disclosure are made more evident in the following detail description, when read in conjunction with the attached drawing figures.

FIG. 1 is a block diagram of an exemplary system for on-demand service according to some embodiments;

FIG. 2 is a schematic diagram illustrating exemplary hardware and software components of a computing device according to some embodiments;

FIG. 3 is a flowchart of an exemplary process for identifying a first group of candidate drivers according to some embodiments;

FIG. 4 is a flowchart of an exemplary process for identifying a candidate driver according to some embodiments;

FIG. 5 is a flowchart of an exemplary process for determining a second group of buyer drivers according to some embodiments;

FIG. 6 is a flowchart of an exemplary process for determining a financial program for a target driver according to some embodiments;

FIG. 7 is a diagram of an exemplary process for determining a purchasing capacity prediction model according to some embodiments; and

FIG. 8 is a flowchart of an exemplary process for determining a target vehicle for a target driver according to some embodiments.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

Moreover, while the systems and methods disclosed in the present disclosure are described primarily regarding evaluating a registered driver, it should also be understood that this is only one exemplary embodiment. The system or method of the present disclosure may be applied to user of any other kind of on-demand service platform. For example, the system or method of the present disclosure may be applied to users in different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for sending and/or receiving an express. The application scenarios of the system or method of the present disclosure may include a webpage, a plug-in of a browser, a client terminal, a custom system, an internal analysis system, an artificial intelligence robot, or the like, or any combination thereof.

The driving routes in the present disclosure may be acquired by positioning technology embedded in a wireless device (e.g., the passenger terminal, the driver terminal, etc.). The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof, One or more of the above positioning technologies may be used interchangeably in the present disclosure. For example, the GPS-based method and the WiFi-based method may be used together as positioning technologies to locate the wireless device.

An aspect of the present disclosure relates to online systems and methods for identifying drivers who might plan to change their vehicles. According to the present disclosure, the systems and methods may identify candidate drivers from millions of drivers registered with the online system in milliseconds or even nanoseconds based on the usage history of their vehicles from the online system. The usage history may include driving routes of a vehicle of the plurality of vehicles, fueling history of the plurality of vehicles, maintenance history of the plurality of vehicles, etc. The systems and methods then may determine their purchasing capacities. If a driver has enough purchase intention and monetary capacity, the systems and methods may proceed to recommend a vehicle to the driver.

It should be noted that the present solution relies on collecting usage data of a vehicle registered with an online system, which is a new form of data collecting means rooted only in post-Internet era. It provides detailed information of a vehicle that could raise only in post-Internet era. In pre-Internet era, it is impossible to collect information of a vehicle such as its driving routes, fueling history, etc. Online on-demand service, however, allows the online platform to monitor millions of thousands of vehicles' behaviors in real-time and/or substantially real-time, and then identify a target driver with enough purchase intention in milliseconds or even nanoseconds. Therefore, the present solution is deeply rooted in and aimed to solve a problem only occurred in post-Internet era.

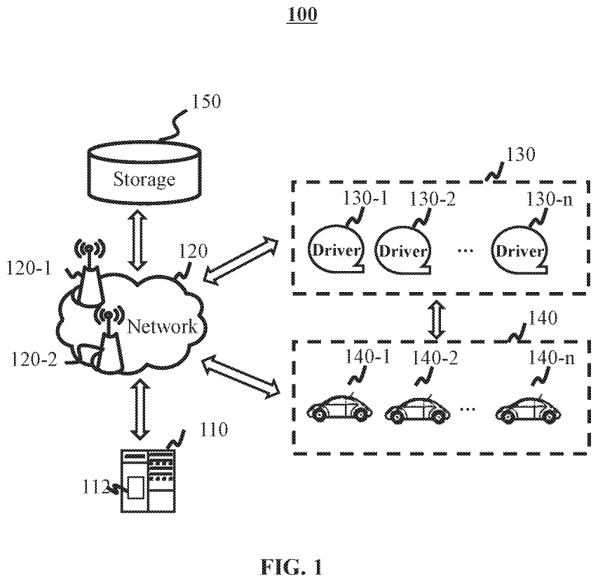

FIG. 1 is a block diagram of an exemplary online platform for on-demand service system 100 according to some embodiments. For example, the online platform may be an online transportation service platform for transportation services such as taxi hailing, chauffeur service, express car, carpool, bus service, driver hire, and shuttle service, etc. As another example, the online platform may be an online financial service platform such as trading service, loan service, insurance service, and mortgage service, etc. The on-demand service system 100 may include a server 110, a network 120, a driver library 130, a vehicle library 140, and a storage 150. The server 110 may include a processor engine 112.

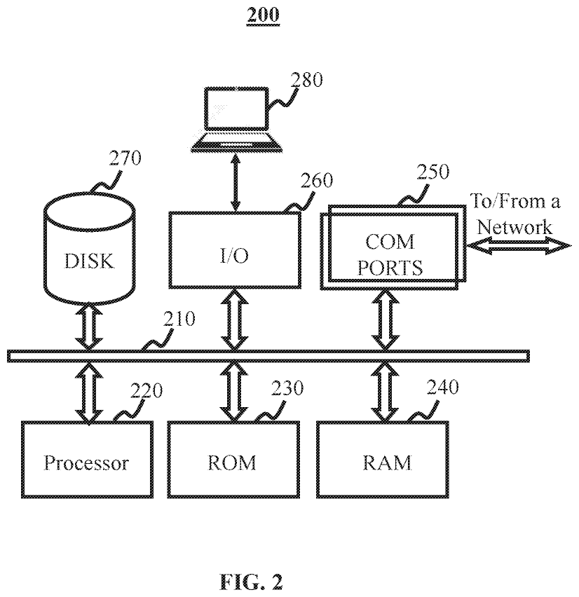

The server 110 may be configured to process information and/or data relating to a driver registered in the online platform 100. For example, the server 110 may identify, from a plurality of drivers registered in the online platform 100, a first group of candidate drivers associated with purchase intentions higher than a threshold value. As another example, the server 110 may determine a financial program for a target driver based on the target purchasing capacity data of the target driver. As still another example, the server 110 may select, from a plurality of on-sale-vehicles, a target vehicle for the target driver based on the usage history of the vehicle associated with the target driver. In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the driver library 130, the vehicle library 140, and/or the storage 150 via the network 120. As another example, the server 110 may be directly connected to the driver library 130, the vehicle library 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing engine 112. The processing engine 112 may process information and/or data relating to the driver registered in the online platform 100 to perform one or more functions of the server 110 described in the present disclosure. For example, the processing engine 112 may identify, from a plurality of drivers registered in the online platform 100, a first group of candidate drivers associated with purchase intentions higher than a threshold value. As another example, the processing engine 112 may determine a financial program for a target driver based on the target purchasing capacity data of the target driver. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the system 100 (e.g., the server 110, the driver library 130, the vehicle library 140, and the storage 150) may send and/or receive information and/or data to/from other component(s) in the system 100 via the network 120. For example, the server 110 may obtain/acquire usage history of a plurality of vehicles associated with the plurality of drivers stored in the storage 150 via the network 120. In some embodiments, information exchanging of one or more components in the system 100 may be achieved by way of connecting to the online platform 100. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the server 110 may include one or more network access points. For example, the server 110 may include wired or wireless network access points such as base stations and/or internet exchange points 120-1, 120-2, through which one or more components of the system 100 may be connected to the network 120 to exchange data and/or information between them.

The driver library 130 may include a plurality of drivers registered in the on-demand platform 100. In some embodiments, the driver library 130 may also include data of the plurality of drivers registered in the online computer platform 100. The data of the plurality of drivers may include driver information such as an age of a driver, driving experience of a driver, a name of a driver, a gender of a driver, an address of a driver, a job of a driver, a log-in situation, a completion of orders on the online platform 100, or the like, or any combination thereof. The data of the plurality of drivers may also include usage history of a plurality of vehicles associated with the plurality of drivers. The usage history may include usage data that the online platform 100 receives when the vehicles are connecting with the online platform 100 and recorded by the online platform 100. For example, the usage history may include driving routes of a vehicle of the plurality of vehicles, driving duration of the plurality of vehicles over the driving routes, active duration of the plurality of drivers in the plurality of vehicles, fueling history of the plurality of vehicles, maintenance history of the plurality of vehicles, online browsing history relating to vehicle purchasing, or the like, or any combination thereof. The fueling history may include fueling data that obtained from gas stations and/or electrical charging stations registered in the online platform 100. The maintenance history may include maintenance data that obtained from vehicle maintenance centers and/or auto repair stations registered in the online platform 100.

The vehicle library 140 may include a plurality of vehicles associated with the plurality of drivers (e.g., drivers in the driver library 130) registered in the online platform 100. In some embodiments, the vehicle library 140 may also include data of the plurality of vehicles associated with the plurality of drivers. The data of the plurality of vehicles may include vehicle information such as a vehicle identity of a vehicle and the corresponding fair market price of the vehicle. The vehicle identity may include a model of the vehicle, a trademark of the vehicle, a license plate of the vehicle, an engine number of the vehicle, an owner name of the vehicle, an identification number of the vehicle. In some embodiments, the data of the plurality of vehicles may also include usage history of a plurality of vehicles associated with the plurality of drivers. The usage history may include usage data the online platform 100 receives when the vehicle is connecting with the online platform 100 and recorded by the online platform 100. For example, the usage history may include driving routes of a vehicle of the plurality of vehicles, driving duration of the plurality of vehicles over the driving routes, active duration of the plurality of drivers in the plurality of vehicles, fueling history of the plurality of vehicles, maintenance history of the plurality of vehicles, online browsing history relating to vehicle purchasing, or the like, or any combination thereof. The fueling history may include fueling data that obtained from gas stations and/or electrical charging stations registered in the online platform 100. The maintenance history may include maintenance data that obtained from vehicle maintenance centers and/or auto repair stations registered in the online platform 100.

In some embodiments, the vehicle in the vehicle library 130 may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

In some embodiments, a driver in the driver library 130 may be associated with one or more vehicles in the vehicle library 140, and a vehicle in the vehicle library 140 may be associated with one or more drivers in the driver library 130. For example, a driver A in the driver library 130 may be associated with two vehicles in the vehicle library 140 as the owner of two vehicles. As another example, a vehicle A in the vehicle library 140 may be associated with two drivers in the driver library 130 as contractors of the vehicle A.

The storage 150 may store data and/or instructions. In some embodiments, the storage 150 may store data obtained/acquired from the drivers registered in the on-demand platform, the vehicles associated with the drivers and/or the server 110. For example, when the vehicle associated with a driver is connecting with the online platform 100, the storage 150 may store data obtained/acquired from the vehicle such as the usage history of the vehicle (e.g., the driving routes, the driving duration, the active duration, the fueling history, the maintenance history, the online browsing history relating to vehicle purchasing, or the like, or any combination thereof). As another example, the storage 150 may store driver information of the drivers obtained/acquired from the drivers registered in the online platform (e.g., the age, the driving experience, the name, the gender, the address, the job, a log-in situation, a completion of orders on the online platform 100, or the like, or any combination thereof). As still another example, the storage 150 may store data of the plurality of vehicles associated with the drivers registered in the online platform (e.g., the identity and the corresponding fair market price of the vehicle). In some embodiments, the storage 150 may store data and/or instructions that the server 110 may execute or use to perform exemplary methods described in the present disclosure. In some embodiments, the storage 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components in the system 100 (e.g., the server 110, the driver library 130, the vehicle library 140, etc.). One or more components in the system 100 may access the data or instructions stored in the storage 150 via the network 120. In some embodiments, the storage 150 may be directly connected to or communicate with one or more components in the system 100 (e.g., the server 110, the driver library 130, the vehicle library 140, etc.). In some embodiments, the storage 150 may be part of the server 110.

In some embodiments, one or more components in the system 100 (e.g., the driver library 130, the vehicle library 140, etc.) may have a permission to access the storage 150. In some embodiments, one or more components in the system 100 may read and/or modify information related to driver, and/or the vehicles when one or more conditions are met. For example, the server 110 may read and/or modify the data stored in the storage 150 when the vehicle is connecting with the online platform 100. As still another example, the driver registered in the online platform may access the data stored in the storage 150 related to the vehicles when the vehicle is connecting with the online platform 100.

In some embodiments, the online platform for on-demand service system 100 may further include a consumption station (or center) of the vehicles connecting with the server 110 and/or the storage 150 via the network 120. The consumption station (or center) may include a gas station, an electrical charging station, a vehicle maintenance center, an auto repair station, a 4S store, or the like, or any combination thereof. In some embodiments, the consumption station (or center) may be registered in the online platform 100. The consumption station (or center) may receive and/or record usage history that the vehicles associated with the drivers registered in the online platform 100 have ever consumed at the consumption station (or center). When connecting to the online platform 100, the consumption station (or center) may send the usage history to one or more components in the online platform 100 (e.g., the storage 150, the server 110, etc.) via the network 120. For example, the gas station may send fueling history of the plurality of vehicles to the storage 150. As another example, the vehicle maintenance center may send maintenance history of the plurality of vehicles to the server 110.

In some embodiments, the online platform 100 may be implemented on a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110 and/or the processing engine 112 may be implemented according to some embodiments of the present disclosure. For example, the processing engine 112 may be implemented on the computing device 200 and configured to perform functions of the processing engine 112 disclosed in this disclosure.

The computing device 200 may be used to implement an on-demand system for the present disclosure. The computing device 200 may implement any component of the on-demand service as described herein. In FIGS. 1-2, only one such computer device is shown purely for convenience purposes. One of ordinary skill in the art would understood at the time of filing of this application that the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor 220, in the form of one or more processors, for executing program instructions. The exemplary computer platform may include an internal communication bus 210, a program storage and a data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the processor 220. The methods and/or processes of the present disclosure may be implemented as the program instructions. The computing device 200 may also include an I/O component 260, supporting input/output between the computer and other components therein such as a user interface element 280. The computing device 200 may also receive programming and data via network communications.

In some embodiments, the processor 220 may include one or more logical circuits for executing computer instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

In some embodiments, the processor 220 may include an acquisition module and a determination module. The acquisition module may be configured to receive data of a plurality drivers registered in an online platform 100. The determination module may be configured to identify from the plurality of drivers a first group of candidate drivers based on the usage history of the plurality of vehicles.

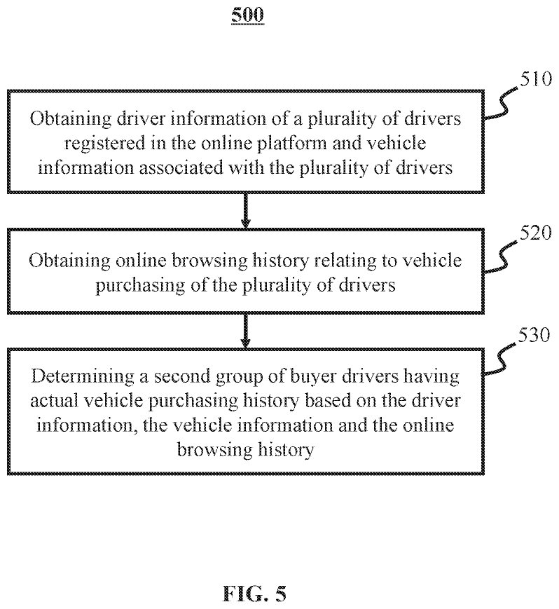

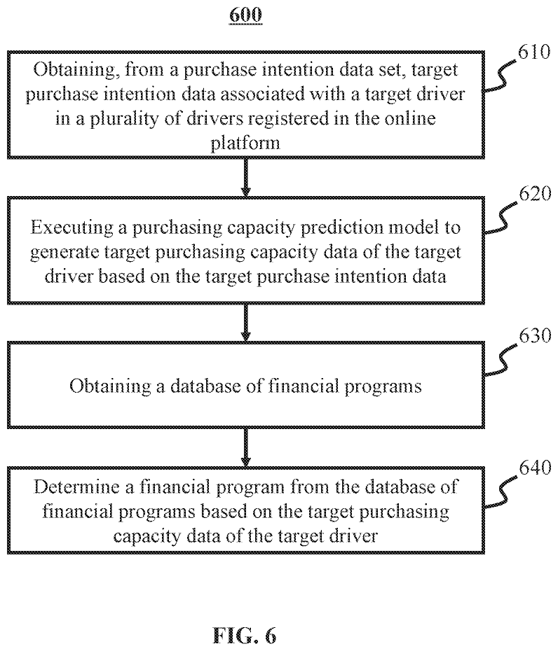

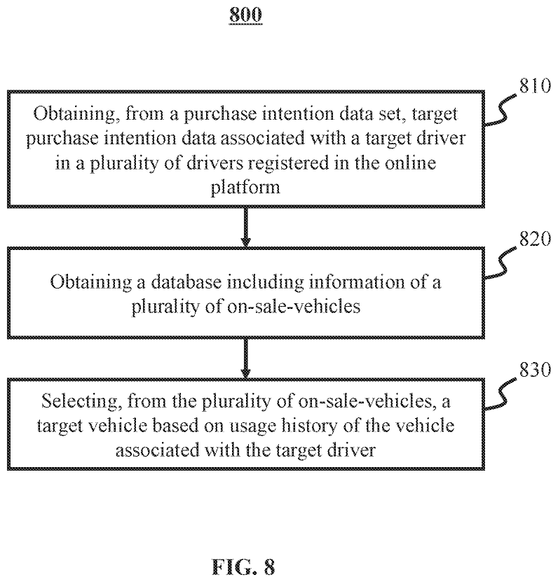

In some embodiments, the determination module may include a buyer driver determination unit, a purchasing intention determination unit, a candidate driver determination unit, a data set determination unit, a financial program determination unit, and a target vehicle determination unit. The buyer driver determination unit may be configured to determine a second group of buyer drivers having actual vehicle purchasing history. For example, the buyer driver determination unit may implement one or more steps illustrated in FIG. 5 in the present disclosure. The purchasing intention determination unit may be configured to determine a purchasing intention of a driver. The candidate driver determination unit may be configured to identify a candidate driver with the purchase intention larger than a threshold value. The data set determination unit may be configured to determine a purchase intention data set. The financial program determination unit may be configured to determine a financial program for a target driver. For example, the financial program determination unit may implement one or more steps illustrated in FIG. 6 in the present disclosure. The target vehicle determination unit may be configured to determine a target vehicle for a target driver. For example, the target vehicle determination unit may implement one or more steps illustrated in FIG. 8 in the present disclosure.

Merely for illustration, only one processor 220 is described in the computing device 200. However, it should be note that the computing device 200 in the present disclosure may also include multiple processors, thus operations and/or method steps that are performed by one processor 220 as described in the present disclosure may also be jointly or separately performed by the multiple processors. For example, if in the present disclosure the processor 220 of the computing device 200 executes both step A and step B, it should be understood that step A and step B may also be performed by two different processors jointly or separately in the computing device 200 (e.g., the first processor executes step A and the second processor executes step B, or the first and second processors jointly execute steps A and B).

One of ordinary skill in the art would understand that when an element of the on-demand service system 100 performs, the element may perform through electrical signals and/or electromagnetic signals. For example, when an input device sends data of a plurality of drivers registered in the online platform 100, a processor of the input device may generate a first electrical signal (or electrical current) encoding the data. The processor of the input device may then send the first electrical signal (or electrical current) encoding the data to an output port. If the input device communicates with the server 110 via a wired network, the output port may be physically connected to a cable, which further transmit the first electrical signal (or electrical current) to an input port of the server 110. If the input device communicates with the server 110 via a wireless network, the output port of the input device may be one or more antennas, which convert the electrical signal (or electrical current) to electromagnetic signal. Similarly, an output device may receive an instruction and/or data from the server 110 via electrical signal (or electrical current) or electromagnet signals. Within an electronic device, such as the input device, the output device, and/or the server 110, when a processor thereof processes an instruction, sends out an instruction, and/or performs an action, the instruction and/or action is conducted via electrical signals (or electrical currents). For example, when the processor retrieves or saves data from a storage medium, it may send out electrical signals (or electrical currents) to a read/write device of the storage medium, which may read or write structured data in the storage medium. The structured data may be transmitted to the processor in the form of electrical signals (or electrical currents) via a bus of the electronic device. Here, an electrical signal (or electrical current) may refer to one electrical signal, a series of electrical signals, and/or a plurality of discrete electrical signals.

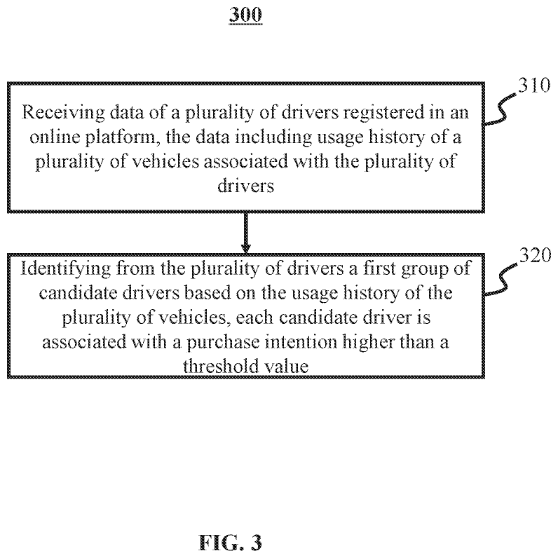

FIG. 3 is a flowchart of an exemplary process and/or method 300 for identifying a first group of candidate drivers according to some embodiments. In some embodiments, the process 300 may be implemented in the system 100 illustrated in FIG. 1. For example, the process 300 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In step 310, the processor 220 (or the acquisition module in the processor 220, or the interface circuits in the processor 220) may receive data of a plurality drivers registered in an online platform 100. The data may include usage history of a plurality of vehicles associated with the plurality of drivers. The processor 220 may be a computer server processor in the online on-demand service platform (e.g., an online computer platform such as a transportation service platform, a transaction service platform, etc.), such as the system 100. In some embodiments, a driver of the plurality of drivers may be associated with one or more vehicles, and a vehicle may be associated with one or more drivers of the plurality of drivers. For example, a driver A of the plurality of drivers may be associated with two vehicles as the owner of two vehicles. As another example, a vehicle A in the vehicle library 140 may be associated with two drivers in the driver library 130 as co-contractors of the vehicle A.

In some embodiments, the usage history may include usage data that the online platform 100 receives when the plurality of vehicles is connecting with and/or logs in the online platform 100 and/or recorded by the online platform 100. For example, the usage history may include driving routes of a vehicle of the plurality of vehicles, driving duration of the plurality of vehicles over the driving routes, active duration of the plurality of drivers in the plurality of vehicles, or the like, or any combination thereof. The driving routes of a vehicle may be obtained from the vehicle, or a terminal of the driver of the vehicle. For example, the vehicle or the terminal of the driver is equipped with GPS. The vehicle or the terminal of the driver may send the location of the vehicle or the terminal of the driver every few predetermined time periods (e.g., every second, every 3 seconds, every 5 seconds, every 10 seconds, etc.) when connecting to the online platform 100. The driving route may include a driver identity, a location, a time, or the like, or any combination thereof. The driving duration of the plurality of vehicles over the driving routes may include quantization values that are obtained from structured data of the driving routes. The active duration of the plurality of drivers in the plurality of vehicles may include quantization values that are obtained from structured data of the driving routes.

In some embodiments, the usage history may also include usage data that the online platform 100 receives from one or more vehicle maintenance stations (or centers) affiliated with the online on-demand service platform. For example, the one or more vehicle maintenance stations may include one or more gas/electrical charging stations, and the usage history may include fueling history of the plurality of vehicles at the one or more gas/electrical charging stations; the one or more vehicle maintenance stations may also include one or more vehicle reparation stations (e.g., body shop, maintenance service station, etc.), and the usage history may include repair or vehicle maintenance history of the plurality of vehicles at the one or more vehicle reparation stations, or the like, or any combination thereof. The fueling history may include fueling data that obtained from gas stations and/or electrical charging stations registered in the online platform 100. The fueling history may include quantization values of the fueling data. The maintenance history may include maintenance data that obtained from vehicle maintenance centers and/or auto repair stations registered in the online platform 100. The maintenance history may include quantization values of the maintenance data (e.g., the vehicle's year, model, mileage, parts repaired, body condition, fair market value, etc.). The consumption information of vehicle accessories may be obtained from 4S stores registered in the online platform 100.

In some embodiments, the usage history may include online data that the online platform 100 receives when connecting with other online platforms. For example; the usage history may include online browsing history relating to vehicle purchasing, online purchasing history relating to vehicle purchasing, online subscription history relating to vehicle purchasing, or the like, or any combination thereof. The online browsing history relating to vehicle purchasing may include browsing data obtained from a browser, an application, a website, or the like, or any combination thereof. The online purchasing history relating to vehicle purchasing may include purchasing data obtained from one or more shopping applications, one or more shopping websites, etc. The online subscription history relating to vehicle purchasing may include subscription data obtained from one or more magazines, websites, applications, stores, etc.

In step 320, the processor 220 (or the determination module in the processor 220, or the processing circuits in the processor 220) may identify from the plurality of drivers a first group of candidate drivers based on the usage history of the plurality of vehicles. Each candidate driver is associated with a purchase intention higher than a threshold value.

In some embodiments, the processor 220 (or the acquisition module in the processor 220, or the processing circuits in the processor 220) may represent the purchase intention as a value (e.g., a distance, a vector, etc.). The threshold value may be varied according to different application scenarios of the on-demand system 100.

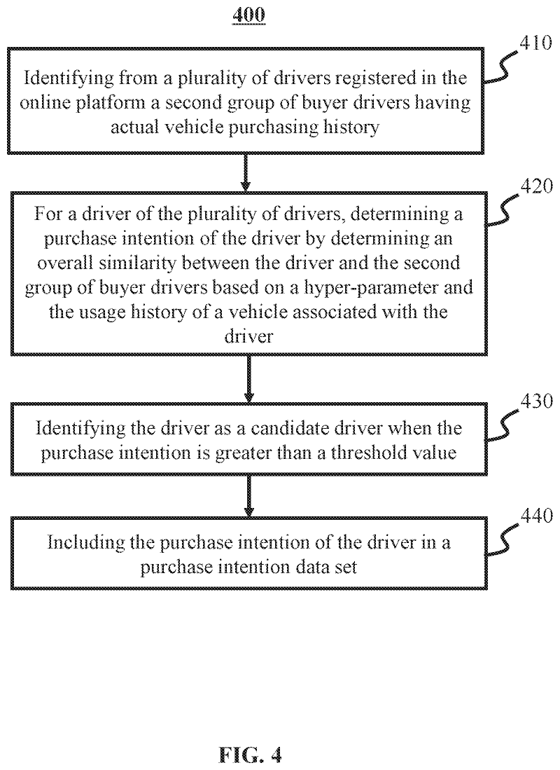

In some embodiments, the processor 220 (or the acquisition module in the processor 220, or the processing circuits in the processor 220) may determine the first group of candidate drivers according to a candidate driver prediction model. Merely by way of example, the candidate driver prediction model may include a decision tree learning model, an association rule learning model, an artificial neural network model, a deep learning model, an inductive logic programming model, a support vector machine model, a Bayesian network model, a reinforcement learning model, a representation learning model, a similarity and metric learning model, or the like, or any combination thereof. In some embodiments, the method of identifying the first group of candidate drivers may be described as the process and/or method 400 illustrated in FIG. 4 in the present disclosure.

In some embodiments, the processor 220 (or the acquisition module in the processor 220, or the processing circuits in the processor 220) may save a first structured data in a storage medium (e.g., a storage 150, a ROM 230, a RAM 240, a disk 270, etc.) of the online platform 100 to identify the first group of candidate drivers after step 320. In some embodiments, the first structured data may encode information of the first group of candidate drives. The first structured data may be transmitted to the processor 220 in the form of electrical signals (or electrical currents) via a bus of the electronic device. The processor 220 (or the acquisition module in the processor 220, or the processing circuits in the processor 220) may retrieves the first structured data stored in the storage medium to identify the first group of candidate drivers.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 300. As another example, all the steps in the exemplary process/method 300 may be implemented in a computer-readable medium including a set of instructions. The instructions may be transmitted in the form of electronic current.

FIG. 4 is a flowchart of an exemplary process and/or method 400 for identifying a candidate driver according to some embodiments. In some embodiments, the process 400 may be implemented in the system 100 illustrated in FIG. 1. For example, the process 400 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, the determination module in the processor 220, or the processing circuits in the processor 220).

In step 410, the processor 220 (or the processing circuits in the processor 220, or the determination module in the processor 220, or the buyer driver determination unit in the determination module) may identify from a plurality of drivers registered in the online platform 100 a second group of buyer drivers having actual vehicle purchasing history. In some embodiments, the method of identifying the second group of buyer drivers may be described as the process and/or method 500 illustrated in FIG. 5 in the present disclosure.

In step 420, for a driver of the plurality of drivers, the processor 220 (or the processing circuits in the processor 220, or the determination module in the processor 220, or the purchasing intention determination unit in the determination module) may determine a purchase intention of the driver by determining an overall similarity between the driver and the second group of buyer drivers based on a hyper-parameter and the usage history of a vehicle associated with the driver.

In some embodiments, the usage history of the vehicle associated with the driver may include quantized features of the driving routes of the vehicle, the driving duration of the driver, the active duration of the driver, the maintenance history of the vehicle, the fueling history of the vehicle, the browsing history relating to vehicle purchasing of the driver, or the like, or any combination thereof.

In some embodiments, the overall similarity may be a mean similarity, an average similarity, etc. The “overall”, “mean”, and “average” herein may be a statistical concept rather than a mathematical concept. For example, the processor 220 (or the processing circuits in the processor 220, or the determination module in the processor 220, or the purchasing intention determination unit in the determination module) may compare the usage history of the driver's vehicle and the usage history of each of the buyer driver's vehicles in the second group. And then to determine the purchase intention of the driver, the processor 220 (or the processing circuits in the processor 220, or the determination module in the processor 220, or the purchasing intention determination unit in the determination module) may determine the similarity between the driver and each buyer driver in the second group of buyer drivers respectively with respect to the usage history. Then, the processor 220 (or the processing circuits in the processor 220, or the determination module in the processor 220, or the purchasing intention determination unit in the determination module) may determine a mean value and/or an average value of these individual similarities, and treat it as the overall similarity. As another example, the processor 220 (or the processing circuits in the processor 220, or the determination module in the processor 220, or the purchasing intention determination unit in the determination module) may first determine a mean value (or an average value, a median) of the usage history of each driver's vehicle in the second group of drivers, and then determine the similarity between the usage history of the driver and mean value (or an average value, a median) of the usage history of each driver's vehicle in the second group of drivers to determine the purchase intention of the driver.

In some embodiments, the similarity may be associated with a distance between the quantized features of the driver and the second group of buyer drivers. For example, the similarity may be in a mathematic relation with the distance such as a rule, a formula, a mapping relation, a reciprocal relation, or the like, or any combination thereof.

In some embodiments, the purchase intention may be represented as a quantized value associated with similarity between the driver and the second group of buyer drivers. For example, the purchase intention may be represented as a distance between the quantized features of the driver and the second group of buyer drivers. As another example, the purchase intention may be represented as a percentage describing the similarity between the driver and the second group of buyer drivers.

It should be noted that the hyper-parameter is only an exemplary algorithm for determine the purchase intention of the driver based on the similarity of the driver and the second group of buyer drivers. The processor 220 (or the processing circuits in the processor 220, or the determination module in the processor 220, or the purchasing intention determination unit in the determination module) may determine the purchase intention of the driver based on other algorithms. For example, the processor 220 (or the processing circuits in the processor 220, or the determination module in the processor 220, or the purchasing intention determination unit in the determination module) may determine the purchase intention of the driver based on a label propagation algorithm (LPA), a classification algorithm, a semi-supervised learning algorithm, or the like, or any combination thereof.

In step 430, the processor 220 (or the processing circuits in the processor 220, or the determination module in the processor 220, or the candidate driver determination unit in the determination module) may identify the driver as a candidate driver when the purchase intention is greater than a threshold value. The threshold value may be varied according to different application scenarios of the on-demand system 100.

In step 440, the processor 220 (or the processing circuits in the processor 220, or the determination module in the processor 220, or the data set determination unit in the determination module) may include the purchase intention of the driver in a purchase intention data set.

In some embodiments, the processor 220 (or the processing circuits in the processor 220, or the determination module in the processor 220, or the data set determination unit in the determination module) may establish a purchase intention data set by executing steps 410-440 on more than one driver of the plurality of drivers. In some embodiments, the processor 220 (or the processing circuits in the processor 220, or the determination module in the processor 220, or the data set determination unit in the determination module) may repeat step 420 and step 430 to determine the purchase intentions of one or more drivers of the plurality of drivers registered in the online platform 100. For example, the processor 220 (or the processing circuits in the processor 220, or the determination module in the processor 220, or the data set determination unit in the determination module) may determine whether each driver of the plurality of drivers registered in the online platform 100 is a candidate driver based on the purchase intention of each driver. The purchase intention data set may include purchase intentions associated with all or part of the drivers registered in the online platform 100. As another example, the processor 220 (or the processing circuits in the processor 220, or the determination module in the processor 220, or the data set determination unit in the determination module) may determine whether a particular number of drivers of the plurality of drivers registered in the online platform 100 are candidate drivers based on the purchase intentions of the particular number of drivers. The purchase intention data set may include purchase intentions associated with the particular number of drivers. The particular number of drivers may be classified as a category or labeled with a tag. For example, the processor 220 (or the processing circuits in the processor 220, or the determination module in the processor 220, or the data set determination unit in the determination module) may determine whether the drivers who have never buy a vehicle are candidate drivers. The purchase intention data set may include purchase intentions of the drivers who have never buy a vehicle. As still another example, the processor 220 (or the processing circuits in the processor 220, or the determination module in the processor 220, or the data set determination unit in the determination module) may determine whether the drivers who are female and/or male. The purchase intention data set may include purchase intentions of the drivers who are female and/or male. In some embodiments, the processor 220 (or the processing circuits in the processor 220, or the determination module in the processor 220, or the data set determination unit in the determination module) may classify and/or label the drivers based on a sparse-id coding method. The processor 220 (or the processing circuits in the processor 220, or the determination module in the processor 220, or the data set determination unit in the determination module) may disperse continuous data. The continuous data may include driving duration of the driver, driving distance of the driver, active duration of the driver, or the like, or any combination thereof. The processor 220 (or the processing circuits in the processor 220, or the determination module in the processor 220, or the data set determination unit in the determination module) may also disperse a category. The category may include a gender of the driver, the age of the driver, the vehicle model associated with the driver, or the like, or any combination thereof.

In some embodiments, the processor 220 (or the processing circuits in the processor 220, or the determination module in the processor 220) may save a second structured data in a storage medium (e.g., a storage 150, a ROM 230, a RAM 240, a disk 270, etc.) of the online platform 100 to identify the driver as a candidate driver when the purchase intention is greater than the threshold value, and include the purchase intention in a purchase intention data set. In some embodiments, the second structured data may encode information of the purchase intention data set. The second structured data may be transmitted to the processor 220 in the form of the electrical signals (or electrical current) via a bus of the electronic device. In some embodiments, the processor 220 (or the processing circuits in the processor 220, or the determination module in the processor 220) may retrieves the second structured data stored in the storage medium to identify the purchase intention data set.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 400. As another example, all the steps in the exemplary process/method 400 may be implemented in a computer-readable medium including a set of instructions. The instructions may be transmitted in the form of electronic current.

FIG. 5 is a flowchart of an exemplary process and/or method 500 for determining a second group of buyer drivers according to some embodiments. The second group of buyer drivers may include drivers having actual vehicle purchasing history of a plurality of drivers registered in the online platform 100. In some embodiments, the process 500 may be implemented in the system 100 illustrated in FIG. 1. For example, the process 500 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, the processing circuits in the processor 220, the determination module in the processor 220, or the buyer driver determination unit).

In step 510, the processor 220 (or the processing circuits in the processor 220, or the determination module in the processor 220, or the buyer driver determination unit in the determination module) may obtain driver information of a plurality of drivers registered in the online platform 100 and vehicle information associated with the plurality of drivers.

The driver information of a driver may include an age of a driver, driving experience of a driver, a name of a driver, a gender of a driver, an address of a driver, a job of a driver, a log-in situation, a completion of orders on the online platform 100, or the like, or any combination thereof. The vehicle information associated with a driver may include a vehicle identity of a vehicle and the corresponding fair market price of the vehicle. The vehicle identity may include a model of the vehicle, a trademark of the vehicle, a license plate of the vehicle, an engine number of the vehicle, an owner name of the vehicle, an identification number of the vehicle. In some embodiments, the driver information and/or the vehicle information may be stored in the any storage medium such as the storage 150, the driver library 130, the vehicle library 140, the server 110 (e.g., the disk 270 of the server 110, the ROM 230 of the server 110, the RAM 240 of the server 110, etc.), an external storage of the online platform 100, or the like, or any combination thereof.

In step 520, the processor 220 (or the processing circuits in the processor 220, or the determination module in the processor 220, or the buyer driver determination unit in the determination module) may obtain online browsing history relating to vehicle purchasing of the plurality of the drivers. In some embodiments, the online browsing history may be stored in any storage medium such as the storage 150, the driver library 130, the vehicle library 140, the server 110 (e.g., the disk 270 of the server 110, the ROM 230 of the server 110, the RAM 240 of the server 110, etc.), an external storage of the online platform 100, or the like, or any combination thereof.

In step 530, the processor 220 (or the processing circuits in the processor 220, or the determination module in the processor 220, or the buyer driver determination unit in the determination module) may determine a second group of buyer drivers having actual vehicle purchasing history based on the driver information, the vehicle information and the online browsing history.

In some embodiments, the processor 220 (or the processing circuits in the processor 220, or the determination module in the processor 220, or the buyer driver determination unit in the determination module) may first identify a third group of drivers having more than one vehicle associated with the drivers based on the driver information, the vehicle information and/or the online browsing history. For example, the processor 220 (or the processing circuits in the processor 220, or the determination module in the processor 220, or the buyer driver determination unit in the determination module) may identify a driver is included in the third group of drivers when the driver is the owner of more than one vehicle based on the driver information and the vehicle information.

The processor 220 (or the processing circuits in the processor 220, or the determination module in the processor 220, or the buyer driver determination unit in the determination module) may then filter out inactive drivers from the third group of drivers. The processor 220 (or the processing circuits in the processor 220, or the determination module in the processor 220, or the buyer driver determination unit in the determination module) may determine a driver as an inactive driver based on the driver information. For example, the processor 220 (or the processing circuits in the processor 220, or the determination module in the processor 220, or the buyer driver determination unit in the determination module) may determine a driver as an inactive driver when the driver has not completed an order for a predetermined time period on the online platform 100. As another example, the processor 220 (or the processing circuits in the processor 220, or the determination module in the processor 220, or the buyer driver determination unit in the determination module) may determine a driver as an inactive driver when the driver has not logged in the online platform 100 for a predetermined time period. The processor 220 (or the processing circuits in the processor 220, or the determination module in the processor 220, or the buyer driver determination unit in the determination module) may determine a driver as an inactive driver based on the online browsing history. For example, the processor 220 (or the processing circuits in the processor 220, or the determination module in the processor 220, or the buyer driver determination unit in the determination module) may determine a driver as an inactive driver when the driver has not browse or subscribe for information relating to vehicle purchasing for a predetermined time period.

The processor 220 (or the processing circuits in the processor 220, or the determination module in the processor 220, or the buyer driver determination unit in the determination module) may then filter out non-private drivers from the third group of drivers. The processor 220 (or the processing circuits in the processor 220, or the determination module in the processor 220, or the buyer driver determination unit in the determination module) may determine a driver as a non-private driver based on the vehicle information. For example, the processor 220 (or the processing circuits in the processor 220, or the determination module in the processor 220, or the buyer driver determination unit in the determination module) may determine a driver as a non-private driver when the vehicle services as a taxi.

In some embodiments, the processor 220 (or the processing circuits in the processor 220, or the determination module in the processor 220, or the buyer driver determination unit in the determination module) may determine the second group of buyer drivers from the third group of drivers after filtering out the inactive drivers, and/or the non-private drivers.

In some embodiments, the processor 220 (or the processing circuits in the processor 220, or the determination module in the processor 220, or the buyer driver determination unit in the determination module) may save a third structured data in a storage medium (e.g., a storage 150, a ROM 230, a RAM 240, a disk 270, etc.) of the online platform 100 to identify the second group of buyer drivers after step 520. The third structured data may encode information of the second group of buyer drivers. The third structured data may be transmitted to the processor 220 in the form of electrical signals (or electrical currents) via a bus of the electronic device. In some embodiments, the processor 220 (or the processing circuits in the processor 220, or the determination module in the processor 220, or the buyer driver determination unit in the determination module) may retrieves the third structured data stored in the storage medium to identify the second group of buyer drivers.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 500. As another example, all the steps in the exemplary process/method 500 may be implemented in a computer-readable medium including a set of instructions. The instructions may be transmitted in the form of electronic current.

FIG. 6 is a flowchart of an exemplary process and/or method 600 for determining a financial program for a target driver according to some embodiments of the present disclosure. In some embodiments, the process 600 may be implemented in the system 100 illustrated in FIG. 1. For example, the process 600 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, the processing circuits in the processor 220, the determination module in the processor 220, or the financial program determination unit in the determination module).

In some embodiments, the processor 220 (or the processing circuits in the processor 220, or the determination module in the processor 220, or the financial program determination unit in the determination module) may recommend at least one financial program to the target driver for an option. In some embodiments, the financial program for buying a vehicle may include a full amount of money to a vehicle, a down payment, an amount of balance payment, an amount of a loan, a period of a loan, a rate of interest, a processing fee, a promotion activity of the vehicle, or the like, or any combination thereof.

In step 610, the processor 220 (or the processing circuits in the processor 220, or the determination module in the processor 220, or the financial program determination unit in the determination module) may obtain, from a purchase intention data set, target purchase intention data associated with a target driver in a plurality of drivers registered in the online computer platform 100.

In some embodiments, the processor 220 (or the processing circuits in the processor 220, or the determination module in the processor 220, or the purchasing intention determination unit in the determination module) may determine the purchase intention data set by executing steps 410-440 in the process 40 on more than one driver of the plurality of drivers. The purchase intention data set may be stored in a storage medium of the online computer platform 100, In some embodiments, the target purchase intention data may predict and/or show whether the target driver has a purchase intention or not. In some embodiments, the processor 220 (or the processing circuits in the processor 220, or the determination module in the processor 220, or the financial program determination unit in the determination module) may identify a candidate driver based on the purchase intention data set. In some embodiments, the processor 220 (or the processing circuits in the processor 220, or the determination module in the processor 220, or the financial program determination unit in the determination module) may determine purchase intention data set based on the candidate drivers.

In some embodiments, the target driver may be any one driver in the plurality of drivers registered in the online platform 100. In some embodiments, the target driver may be a driver in a particular number of drivers registered in the online platform 100. The particular number of drivers may be classified as a category or labeled with a tag. For example, the processor 220 (or the processing circuits in the processor 220, or the determination module in the processor 220, or the financial program determination unit in the determination module) may obtain target purchase intention data associated with a target driver who has never buy a vehicle.

In step 620, the processor 220 (or the processing circuits in the processor 220, or the determination module in the processor 220, or the financial program determination unit in the determination module) may execute a purchasing capacity prediction model to generate target purchasing capacity data of the target driver based on the target purchase intention data.

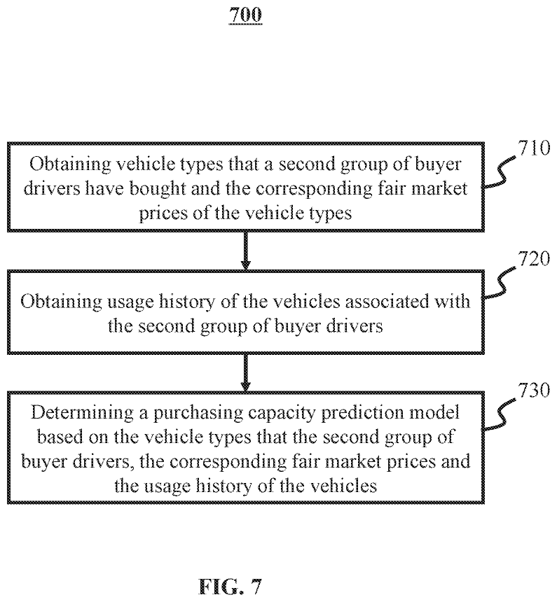

The target purchasing capacity data of the target driver may refer to a range of money affordable for the target driver for buying a vehicle. For example, a target driver A may be predicted to have a saving of 10-15 thousand USD according to his/her purchasing capacity data. In some embodiments, the processor 220 (or the processing circuits in the processor 220, or the determination module in the processor 220, or the financial program determination unit in the determination module) may repeat executing the purchasing capacity prediction model based on the purchase intention data of the plurality of drivers registered in the online platform to generate a purchasing capacity data set and store the purchasing capacity data set in the storage medium. In some embodiments, the processor 220 (or the processing circuits in the processor 220, or the determination module in the processor 220, or the financial program determination unit in the determination module) may determine the purchasing capacity prediction mod& based on the vehicle types that the second group of buyer drivers bought, the corresponding fair market prices of the vehicle types and the usage history of vehicles associated with the second group of buyer drivers. In some embodiments, the method of determining a purchasing capacity prediction model may be described as the process and/or method 700 illustrated in FIG. 7 in the present disclosure.

In step 630, the processor 220 (or the processing circuits in the processor 220, or the determination module in the processor 220, or the financial program determination unit in the determination module) may obtain a database of financial programs. The database of financial programs may be provided by the financial institutions and stored in a storage medium of the online platform 100. In some embodiments, the financial program may include a discount of buying a vehicle by cash, a discount of group-buying, an estimated total price of a vehicle, a down payment amount, an amount of balance payment, an amount of a loan, a period of a loan, a rate of interest, a processing fee, a promotion activity of the vehicle, or the like, or any combination thereof. In some embodiments, the financial institutions may provide at least one financial programs for different vehicle purchases. In some embodiments, the financial programs in the database of financial programs may be varied according to different scenarios of the on-demand system 100. For example, the financial programs may be varied at different time period after appearing on the auto market. In some embodiments, the processor 220 (or the processing circuits in the processor 220, or the determination module in the processor 220, or the financial program determination unit in the determination module) may update the database of financial programs in real time.

In step 640, the processor 220 (or the processing circuits in the processor 220, or the determination module in the processor 220, or the financial program determination unit in the determination module) may determine a financial program from the database of financial programs based on the target purchasing capacity data of the target driver. The processor 220 (or the processing circuits in the processor 220, or the determination module in the processor 220, or the financial program determination unit in the determination module) may match the financial program with corresponding amount of money that the target driver is affordable according to the driver's purchasing capacity. For example, for the target driver A who is predicted to have a saving of 10-15 thousand USD according to his/her purchasing capacity data, the processor 220 (or the processing circuits in the processor 220, or the determination module in the processor 220, or the financial program determination unit in the determination module) may determine at least one financial program with an estimated total price of 10-15 thousand USD of a vehicle for the target driver A. Then the processor 220 (or the processing circuits in the processor 220, or the determination module in the processor 220, or the financial program determination unit in the determination module) may recommend the financial program to the target drivers. The processor 220 (or the processing circuits in the processor 220, or the determination module in the processor 220, or the financial program determination unit in the determination module) may recommend to the financial program to the target driver by sending information to an interface of an application installed in the target driver's electronic device (e.g., a driver terminal of the target driver), sending a message to the target driver's mobile phone, calling the driver, sending a mail or an e-mail; or the like, or any combination thereof.

In some embodiments, the processor 220 (or the processing circuits in the processor 220, or the determination module in the processor 220, or the financial program determination unit in the determination module) may save a fourth structured data in a storage medium (e.g., a storage 150, a ROM 230, a RAM 240, a disk 270, etc.) of the online platform 100 to being associated with the target driver with the target financial program after step 640. The fourth structured data may encode information being associated the target driver with the target financial program. The fourth structured data may be transmitted to the processor 220 in the form of electrical signals (or electrical currents) via a bus of the electronic device. In some embodiments, the processor 220 (or the processing circuits in the processor 220, or the determination module in the processor 220, or the financial program determination unit in the determination module) may retrieves the fourth structured data stored in the storage medium to associate the target driver with the target financial program.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process/method 600, As another example, all the steps may be implemented in a computer-readable medium including a set of instructions. The instructions may be transmitted in the form of electronic current.

FIG. 7 is a flowchart of an exemplary process and/or method 700 for determining a purchasing capacity prediction model according to some embodiments of the present disclosure. In some embodiments, the process 700 may be implemented in the system 100 illustrated in FIG. 1, For example, the process 700 may be stored in the database 150 and/or the storage (e.g., the ROM 230, the RAM 240, etc.) as a form of instructions, and invoked and/or executed by the server 110 (e.g., the processing engine 112 in the server 110, the processor 220 of the processing engine 112 in the server 110, the processing circuits in the processor 220, the determination module in the processor 220, or the financial program determination unit in the determination module).

The purchasing capacity prediction model may predict the amount of money that the driver may afford to buy a vehicle. In some embodiments, the amount of money may include an exact number of money, a range of money, etc. In some embodiments, the purchasing capacity prediction model may also include at least one candidate vehicle associated with the predicted purchasing capacity of the target driver.

In step 710, the processor 220 (or the processing circuits in the processor 220, or the determination module in the processor 220, or the financial program determination unit in the determination module) may obtain vehicle types that a second group of buyer drivers have bought and the corresponding fair market prices of the vehicle types,

In some embodiments, one vehicle type may include a brand of the vehicle, a model of the vehicle, a configuration of the vehicle, a year of manufacture, a color of the vehicle, or the like, or any combination thereof. The configuration of the vehicle may include settings of the vehicle under a model, such as an interior collocations of the vehicle (e.g., a seat, a console, a window, etc.), an external collocation of the vehicle (e.g., paint of the vehicle, a tyre of the vehicle, a rearview mirror, etc.), an automobile part of the vehicle, etc. In some embodiments, the vehicle types that the second group of buyer drivers have bought and/or the corresponding fair market prices may be stored in a storage medium of the online computer platform 100. For example, the vehicle types that the second group of buyer drivers have bought and the corresponding fair market prices may be recorded as a vehicle purchasing data set of the driver. The vehicle purchasing data set may be stored in a storage medium of the online computer platform. In some embodiments, the vehicle types that the second group of buyer drivers have bought may be stored in a storage medium of the online platform 100. The processor 220 (or the processing circuits in the processor 220, or the determination module in the processor 220, or the financial program determination unit in the determination module) may match the corresponding fair market prices associated with the vehicle types from a database of all on-sale-vehicles.

In step 720, the processor 220 (or the processing circuits in the processor 220, or the determination module in the processor 220, or the financial program determination unit in the determination module) may obtain usage history of the vehicles associated with the second group of buyer drivers. The usage history may be stored in a storage medium of the online platform. In some embodiments, the usage history may include driving routes of vehicles associated with the second group of buyer drivers, driving duration of the vehicles over the driving routes, active duration of the buyer drivers, fueling history of the vehicles associated with the second group of buyer drivers, maintenance history (with vehicle maintenance centers/auto repair stations registered with the online computer platform) of the vehicles associated with the second group of buyer drivers, online browsing history relating to vehicle purchasing of the buyer drivers, or the like, or any combination thereof.

In step 730, the processor 220 (or the processing circuits in the processor 220, or the determination module in the processor 220, or the financial program determination unit in the determination module) may determine a purchasing capacity prediction model based on the vehicle types that the second group of buyer drivers have bought, the corresponding fair market prices and the usage history of the vehicles associated with the second group of buyer drivers. In some embodiments, the processor 220 (or the processing circuits in the processor 220, or the determination module in the processor 220, or the financial program determination unit in the determination module) may generate a purchasing capacity of a driver based by executing the purchasing capacity perdition model. The purchasing capacity herein may refer to the specific amount of money that the driver can afford to buy a vehicle. In some embodiments, the purchasing capacity prediction model may include a decision tree learning model, an association rule learning model, an artificial neural network model, a deep learning model, an inductive logic programming model, a support vector machine model, a Bayesian network model, a reinforcement learning model, a representation learning model, a similarity and metric learning model, or the like, or any combination thereof. In some embodiments, the processor 220 (or the processing circuits in the processor 220, or the determination module in the processor 220, or the financial program determination unit in the determination module) may execute the purchasing capacity prediction model on a target driver to generate the target purchasing capacity data based on the target purchase intention data. The processor 220 (or the processing circuits in the processor 220, or the determination module in the processor 220, or the financial program determination unit in the determination module) may store the target purchasing capacity data in a storage medium for further operations. In some embodiments, the purchasing capacity prediction model may be updated according to the real-time updating parameters of the online platform 100.

In some embodiments, the processor 220 (or the processing circuits in the processor 220, or the determination module in the processor 220, or the financial program determination unit in the determination module) may save a fifth structured data in a storage medium (e.g., a storage 150, a ROM 230, a RAM 240, a disk 270, etc.) of the online platform 100 to identify the purchasing capacity prediction model after step 730. The fifth structured data may encode information of the purchasing capacity prediction model. The fifth structured data may be transmitted to the processor 220 in the form of electrical signals (or electrical currents) via a bus of the electronic device. In some embodiments, the processor 220 (or the processing circuits in the processor 220, or the determination module in the processor 220, or the financial program determination unit in the determination module) may retrieves the fifth structured data stored in the storage medium to identify the purchasing capacity prediction model.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 700. As another example, all the steps may be implemented in a computer-readable medium including a set of instructions. The instructions may be transmitted in the form of electronic current.

FIG. 8 is a flowchart of an exemplary process and/or method 800 for determining a target vehicle for a target driver according to some embodiments of the present disclosure. In some embodiments, the process 800 may be implemented in the system 100 illustrated in FIG. 1. For example, the process 800 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110, the processing circuits in the processor 220, the determination module in the processor 220, or the target vehicle determination unit in the determination module).

In step 810, the processor 220 (or the processing circuits in the processor 220, or the determination module in the processor 220, or the target vehicle determination unit in the determination module) may obtain, from a purchase intention data set, target purchase intention data associated with a target driver in a plurality of drivers registered in the online platform 100.

In some embodiments, for one or more drivers of the plurality drivers, the processor 220 (or the processing circuits in the processor 220, or the determination module in the processor 220, or the purchasing intention determination unit in the determination module) may determine the purchase intention data set by executing steps 410-440 in the process 400 on more than one driver of the plurality of drivers. The purchase intention data set may be stored in a storage medium of the online computer platform 100. In some embodiments, the target purchase intention data may predict whether the target driver has a purchase intention or not. In some embodiments, the processor 220 (or the processing circuits in the processor 220, or the determination module in the processor 220, or the target vehicle determination unit in the determination module) may identify a candidate driver based on the purchase intention data set.

In some embodiments, the processor 220 (or the processing circuits in the processor 220, or the determination module in the processor 220, or the target vehicle determination unit in the determination module) may further obtain usage history of the vehicle associated with the target driver. The usage history may include driving routes of the vehicle, parking spots of the vehicle, driving duration of the vehicle, active duration of the driver associated with the vehicle, fueling history of the vehicle, maintenance history of the vehicle, or the like, or any combination thereof.

In step 820, the processor 220 (or the processing circuits in the processor 220, or the determination module in the processor 220, or the target vehicle determination unit in the determination module) may obtain a database including information of a plurality of on-sale-vehicles. The information of the plurality of on-sale-vehicles may include vehicle types, the corresponding fair market prices of the vehicle types, discount of buying a vehicle, performances of the vehicle types, or the like, or any combination thereof. In some embodiments, the processor 220 (or the processing circuits in the processor 220, or the determination module in the processor 220, or the target vehicle determination unit in the determination module) may obtain the database including information of the plurality of on-sale-vehicles from auto trading websites, auto trading houses, advertisements, newspapers, automobile APPs, or the like, or any combination thereof. In some embodiments, the processor 220 (or the processing circuits in the processor 220, or the determination module in the processor 220, or the target vehicle determination unit in the determination module) may update the database of the information of a plurality of on-sale-vehicles every period of time (e.g., an hour, a day, a week, a month, etc.).

In step 830, the processor 220 (or the processing circuits in the processor 220, or the determination module in the processor 220, or the target vehicle determination unit in the determination module) may select, from the plurality of on-sale-vehicles, a target vehicle based on the usage history of the vehicle associated with the target driver. The processor 220 (or the processing circuits in the processor 220, or the determination module in the processor 220, or the target vehicle determination unit in the determination module) may select an appropriate vehicle for the target driver. The appropriate vehicle may be a recommended vehicle that is suitable for the target driver. In some embodiments, the processor 220 (or the processing circuits in the processor 220, or the determination module in the processor 220, or the target vehicle determination unit in the determination module) may recommend the target vehicle to the target driver. For example, if the processor 220 (or the processing circuits in the processor 220, or the determination module in the processor 220, or the target vehicle determination unit in the determination module) determine that the target driver often dives in deserts based on the usage history of the vehicle associated with the target driver, the processor 220 (or the processing circuits in the processor 220, or the determination module in the processor 220, or the target vehicle determination unit in the determination module) may select a sport utility vehicle (SUV) from the plurality of on-sale-vehicles for the target driver. The processor 220 (or the processing circuits in the processor 220, or the determination module in the processor 220, or the target vehicle determination unit in the determination module) may also recommend the SUV to the target driver through a push information of an application installed on the driver terminal of the target driver. As another example, the processor 220 (or the processing circuits in the processor 220, or the determination module in the processor 220, or the target vehicle determination unit in the determination module) may determine that the target driver often occurs accidents based on the maintenance history of the vehicle associated with the target driver, the processor 220 (or the processing circuits in the processor 220, or the determination module in the processor 220, or the target vehicle determination unit in the determination module) may select a highly safe vehicle for the target driver.

In some embodiments, the processor 220 (or the processing circuits in the processor 220, or the determination module in the processor 220, or the target vehicle determination unit in the determination module) may save a sixth structured data in a storage medium (e.g., a storage 150, a ROM 230, a RAM 240, a disk 270, etc.) of the online platform 100 to being associated with the target driver with the target vehicle after step 830. The sixth structured data may encode information being associated the target driver with the target vehicle. The sixth structured data may be transmitted to the processor 220 (or the processing circuits in the processor 220, or the determination module in the processor 220, or the target vehicle determination unit in the determination module) in the form of electrical signals (or electrical currents) via a bus of the electronic device. In some embodiments, the processor 220 (or the processing circuits in the processor 220, or the determination module in the processor 220, or the target vehicle determination unit in the determination module) may retrieves the sixth structured data stored in the storage medium to associate the target driver with the target vehicle.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 800. As another example, all the steps may be implemented in a computer-readable medium including a set of instructions. The instructions may be transmitted in the form of electronic current.

It should be noted that the structured data described as “the first”, “the second”, “the third”, “the fourth”, “the fifth”, and “the sixth” is merely provided for illustration purpose, and not intended to limit the scope of the present disclosure. For persons having ordinary skills in the art, multiple variations and modifications may be made under the teachings of the present disclosure. However, those variations and modifications do not depart from the scope of the present disclosure. For example, the six structured data may be included in a whole structured data as different sections in the form of electrical signal (or electrical current). The processor 220 may save the whole structured data in a storage medium to identify different details described as “the first”, “the second”, “the third”, “the fourth”, “the fifth”, and “the sixth”. As another example, two or more structured data in the six structured data may be combined as one structured data.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by the present disclosure, and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for providing a driver registered in an online computer platform with a financial program for buying a vehicle, comprising:
at least one computer-readable storage medium including a set of instructions for providing a driver registered in an online computer platform with a financial program for buying a vehicle; and
at least one processor in communication with the computer-readable storage medium, wherein when executing the set of instructions, the at least one processor is directed to:
receive data of a plurality of drivers registered in the online computer platform, the data including usage history of a plurality of vehicles associated with the plurality of drivers;
identify, from the plurality of drivers, a first group of candidate drivers based on the usage history of the plurality of vehicles, each candidate driver is associated with a purchase intention higher than a threshold value; and
save a first structured data in the storage medium to identify the first group of candidate drivers.

2. The system of claim 1, wherein the usage history includes at least one of:
driving routes of a vehicle of the plurality of vehicles;
driving duration of the plurality of vehicles over the driving routes;
active duration of the plurality of drivers in the plurality of vehicles;
fueling history of the plurality of vehicles;
maintenance history of the plurality of vehicles; or
online browsing history relating to vehicle purchasing.

3. The system of claim 1, wherein to identify the first group of candidate drivers, the at least one processor is further directed to:
identify, from the plurality of drivers, a second group of buyer drivers having actual vehicle purchasing history;
for a driver of the plurality of drivers,
determine an overall similarity between the driver and the second group of buyer drivers based on a hyper-parameter and the usage history of a vehicle associated with the driver;
determine a purchase intention of the driver based on the overall similarity; and
save a second structured data in the storage medium to:
identify the driver as a candidate driver when the purchase intention is greater than the threshold value; and
include the purchase intention of the driver in a purchase intention data set.

4. The system of claim 3, wherein to identify the second group of buyer drivers having actual vehicle purchasing history, the at least one processor is further directed to:
access the storage medium of the online computer platform to obtain driver information of the plurality of drivers and vehicle information associated with the plurality of drivers;
access the storage medium of the online computer platform to obtain online browsing history relating to vehicle purchasing of the plurality of drivers;
determine the second group of buyer drivers having actual vehicle purchasing history based on the driver information, the vehicle information and the online browsing history; and
save a third structured data in the storage medium to identify the second group of buyer drivers.

5. The system of claim 3, wherein the at least one processor is further directed to:
access the storage medium of the online computer platform to obtain from the purchase intention data set target purchase intention data associated with a target driver among the plurality of drivers;
execute a purchasing capacity prediction model to generate target purchasing capacity data of the target driver based on the target purchase intention data;
access the storage medium to read a database of financial programs;
determine a financial program from the database of financial programs based on the target purchasing capacity data of the target driver; and
save a fourth structured data in the storage medium, the structured data associated the target driver with the target financial program.

6. The system of claim 5, wherein the at least one processor is further directed to:
access the storage medium of the online computer platform to obtain vehicle types that the second group of buyer drivers have bought and the corresponding fair market prices;
access the storage medium to obtain usage history of the vehicles associated with the second group of buyer drivers;
determine a purchasing capacity prediction model based on the vehicle types, the corresponding fair market prices and the usage history of the vehicles associated with the second group of buyer drivers; and
save a fifth structured data in the storage medium to identify the purchasing capacity prediction model.

7. The system of claim 3, wherein the at least one processor is further directed to:
access the storage medium of the online computer platform to obtain, from the purchase intention data set, target purchase intention data associated with a target driver among the plurality of drivers;
access the storage medium to obtain a database including information of a plurality of on-sale-vehicles;
select, from the plurality of on-sale-vehicles, a target vehicle based on the usage history of the vehicle associated with the target driver; and
save a sixth structured data in the storage medium, the structured data associated the target driver with the target vehicle.

8. A method for providing a driver registered in an online computer platform with a financial program for buying a vehicle, comprising:
receiving data of a plurality of drivers registered in the online computer platform, the data including usage history of a plurality of vehicles associated with the plurality of drivers;
identifying from the plurality of drivers a first group of candidate drivers based on the usage history of the plurality of vehicles, each candidate driver is associated with a purchase intention higher than a threshold value; and
saving a first structured data in a storage medium to identify the first group of candidate drivers.

9. The method of claim 8, wherein the usage history includes at least one of:
driving routes of a vehicle of the plurality of vehicles;
driving duration of the plurality of vehicles over the driving routes;
active duration of the plurality of drivers in the plurality of vehicles;
fueling history of the plurality of vehicles;
maintenance history of the plurality of vehicles; or
online browsing history relating to vehicle purchasing.

10. The method of claim 8, wherein the identifying the first group of candidate drivers comprising:
identifying from the plurality of drivers a second group of buyer drivers having actual vehicle purchasing history;
for a driver of the plurality of drivers,
determining an overall similarity between the driver and the second group of buyer drivers based on a hyper-parameter and the usage history of a vehicle associated with the driver;
determining a purchase intention of the driver based on the overall similarity; and
saving a second structured data in the storage medium to:
identify the driver as a candidate driver when the purchase intention is greater than the threshold value; and
include the purchase intention of the driver in a purchase intention data set.

11. The method of claim 10, wherein the identifying the second group of buyer drivers having actual vehicle purchasing history comprising:
accessing the storage medium of the online computer platform to obtain driver information of the plurality of drivers and vehicle information associated with the plurality of drivers;
accessing the storage medium of the online computer platform to obtain online browsing history relating to vehicle purchasing of the plurality of drivers;
determining the second group of buyer drivers having actual vehicle purchasing history based on the driver information, the vehicle information and the online browsing history; and
saving a third structured data in the storage medium to identify the second group of buyer drivers.

12. The method of claim 10 further comprising:
accessing the storage medium of the online computer platform to obtain from the purchase intention data set target purchase intention data associated with a target driver in the plurality of drivers;
executing a purchasing capacity prediction model to generate target purchasing capacity data of the target driver based on the target purchase intention data;
accessing the storage medium to read a database of financial programs;
determining a financial program from the database of financial programs based on the target purchasing capacity data of the target driver; and
saving a fourth structured data in the storage medium, the structured data associated the target driver with the target financial program.

13. The method of claim 12 further comprising:
accessing the storage medium of the online computer platform to obtain vehicle types that the second group of buyer drivers have bought and the corresponding fair market prices;
accessing the storage medium to obtain usage history of the vehicles associated with the second group of buyer drivers;
determining a purchasing capacity prediction model based on the vehicle types, the corresponding fair market prices and the usage history of the vehicles associated with the second group of buyer drivers; and
saving a fifth structured data in the storage medium to identify the purchasing capacity prediction model.

14. The method of claim 10 further comprising:
accessing the storage medium of the online computer platform to obtain, from the purchase intention data set, target purchase intention data associated with a target driver among the plurality of drivers;
accessing the storage medium to obtain a database including information of a plurality of on-sale-vehicles;
selecting, from the plurality of on-sale-vehicles; a target vehicle based on the usage history of the vehicle associated with the target driver; and
saving a sixth structured data in the storage medium, the structured data associated the target driver with the target vehicle.

15. A non-transitory computer readable medium, comprising at least one set of instructions for providing a driver registered in an online computer platform with a financial program for buying a vehicle, wherein when executed by at least one processor of a computer server, the at least one set of instructions directs the at least one processor to perform acts of:
receiving data of a plurality of drivers registered in the online computer platform, the data including usage history of a plurality of vehicles associated with the plurality of drivers;
identifying from the plurality of drivers a first group of candidate drivers based on the usage history of the plurality of vehicles, each candidate driver is associated with a purchase intention higher than a threshold value; and
saving a first structured data in a storage medium to identify the first group of candidate drivers.

16. The non-transitory computer readable medium of claim 15, wherein the usage history includes at least one of:
driving routes of a vehicle of the plurality of vehicles;
driving duration of the plurality of vehicles over the driving routes;
active duration of the plurality of drivers in the plurality of vehicles;
fueling history of the plurality of vehicles;
maintenance history of the plurality of vehicles; or
online browsing history relating to vehicle purchasing.

17. The non-transitory computer readable medium of claim 15, wherein the identifying the first group of candidate drivers includes:
identifying from the plurality of drivers a second group of buyer drivers having actual vehicle purchasing history;
for a driver of the plurality of drivers,
determining an overall similarity between the driver and the second group of buyer drivers based on a hyper-parameter and the usage history of a vehicle associated with the driver;
determining a purchase intention of the driver based on the overall similarity; and
saving a second structured data in the storage medium to:
identify the driver as a candidate driver when the purchase intention is greater than the threshold value; and
include the purchase intention of the driver in a purchase intention data set.

18. The non-transitory computer readable medium of claim 17, the at least one set of instructions further directs the at least one processor to perform acts of:
accessing the storage medium of the online computer platform to obtain from the purchase intention data set target purchase intention data associated with a target driver among the plurality of drivers;
executing a purchasing capacity prediction model to generate target purchasing capacity data of the target driver based on the target purchase intention data;
accessing the storage medium to read a database of financial programs;
determining a financial program from the database of financial programs based on the target purchasing capacity data of the target driver; and
saving a fourth structured data in the storage medium, the structured data associated the target driver with the target financial program.

19. The non-transitory computer readable medium of claim 18, the at least one set of instructions further directs the at least one processor to perform acts of:
accessing the storage medium of the online computer platform to obtain vehicle types that the second group of buyer drivers have bought and the corresponding fair market prices;
accessing the storage medium to obtain usage history of the vehicles associated with the second group of buyer drivers;
determining a purchasing capacity prediction model based on the vehicle types, the corresponding fair market prices and the usage history of the vehicles associated with the second group of buyer drivers; and
saving a fifth structured data in the storage medium to identify the purchasing capacity prediction model.

20. The non-transitory computer readable medium of claim 17, the at least one set of instructions further directs the at least one processor to perform acts of:
accessing the storage medium of the online computer platform to obtain, from the purchase intention data set, target purchase intention data associated with a target driver among the plurality of drivers;
accessing the storage medium to obtain a database including information of a plurality of on-sale-vehicles;
selecting, from the plurality of on-sale-vehicles, a target vehicle based on the usage history of the vehicle associated with the target driver; and
saving a sixth structured data in the storage medium, the structured data associated the target driver with the target vehicle.
